(19) United States
(12) Patent Application Publication
(10) Pub. No.: US 2018/0356988 A1
(43) Pub. Date: Dec. 13, 2018

(54) FILE TRANSFER SYSTEM AND METHOD

(71) Applicant: Noah Fischer, Golden Beach, FL (US)

(72) Inventor: Noah Fischer, Golden Beach, FL (US)

(21) Appl. No.: 16/003,354

(22) Filed: Jun. 8, 2018

(51) Int. Cl. G06F 3/06; G06F 17/30; G06F 21/31

(52) U.S. Cl. CPC G06F 3/065; G06F 3/0604; G06F 3/0643; G06F 3/0652; G06F 21/31; G06F 17/30079; G06F 17/30117; G06F 17/30138; G06F 3/067

(57) ABSTRACT

A file transfer system and method that allows for the transfer of digital files from user input devices to computing devices without the need of an additional peripheral storage device. The system may include a first computing device, a second computing device, and a user input device. The user input device may include device storage memory accessible by the first computing device and the second computing device. The first computing device and the second computing device may include a first file storage area and a second file storage area, respectively. One or more digital files stored in the device storage memory of the user input device can be transferred to the first file storage area of the first computing device, or the second file storage area of the second computing device. Further, one or more digital files stored on the first file storage area of the first computing device, or the second file storage area of the second computing device can be transferred to the device storage memory of the user input device.

### FIELD OF INVENTION

The invention relates generally to the transferring of files in computer-based environments, and in particular to a digital file transfer system and method to transfer digital files between user input devices and computing devices.

### BACKGROUND OF THE INVENTION

A digital file is a computer resource for recording data discretely in a computer storage device. There are various types of digital files that are designed to store one or more types of data. For example, digital files may store text, images, audio, video, or any other form of information that can exist in a computer-based environment. Through computer programs, a user can access, modify, copy, transfer, or delete digital files. Customarily, peripheral data storage devices such as USB flash drives and external hard drives facilitate the transfer of digital files from one computing device to another; however, the use of these devices requires the user to transport these devices with them at all times to ensure that digital files may be transferred at a moment's notice. Even cloud storage presents a disadvantage in that a user needs internet access to facilitate the transfer of digital files.

Peripheral devices such as input devices may be utilized to provide data and control signals to computing devices. Examples of common input devices include keyboards, mice, joysticks, and the like. Input devices such as these are generally used to control or interact with various objects rendered on a computing device's user interface. However, input devices tailored to store or retrieve digital files provide an advantage in that most computing devices utilize the functionality of input devices perpetually. For example, a conventional desktop or laptop necessarily needs a keyboard or a trackpad for a user to effectively utilize the computing device. Therefore, employing input devices that are designed to receive, store, and transfer digital files allows a user to conveniently and effortlessly transfer digital files from one computing device to another, without having to transport additional peripheral storage devices.

Accordingly, the current invention aims to provide a file transfer system and method that mitigates the disadvantages of current file transfer techniques by allowing the transfer of digital files between an input device and a computing device without the need for additional peripheral storage devices.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure is directed to a file transfer system and method that allows for the transfer of digital files from user input devices to computing devices without the need of an additional peripheral storage device.

The system may include a first computing device, a second computing device, and a user input device. The user input device may include device storage memory accessible by the first computing device and the second computing device. The exemplary device storage memory may comprise any computer readable storage media readable by the first computing device or the second computing device and capable of receiving, transferring, and storing one or more digital files. The first computing device and the second computing device may include a first file storage area and a second file storage area, respectively.

One or more digital files stored in the device storage memory of the user input device can be transferred to the first file storage area of the first computing device, or the second file storage area of the second computing device. Further, one or more digital files stored on the first file storage area of the first computing device, or the second file storage area of the second computing device can be transferred to the device storage memory of the user input device.

A method of transferring a selected digital file from a first file storage area in a first computing device to a second file storage area in a second computing device can include, providing a user input device comprising a device storage memory; establishing a connection between the user input device and the first computing device; storing the selected digital file in the first file storage area; determining whether the selected digital file is not already stored in the device storage memory; copying the selected digital file from the first storage area to the device storage memory; establishing a connection between the user input device and the second computing device; determining whether the selected digital file is already stored in the second file storage area; copying the selected digital file from the device storage memory to the second file storage area; and deleting the selected file from the device storage memory.

These and other features and advantages will be apparent from a reading of the following detailed description, and a review of the appended drawings. It is to be understood that the foregoing summary, the following detailed descriptions, and the appended drawings are only explanatory and are not restrictive of various aspects claimed.

Although the invention is illustrated and described herein as implemented in connection with a file transfer system and method, it is nevertheless not intended to be limited to only the details shown, since various modifications and structural changes may be made therein without departing from the spirit of the invention and within the scope and range of equivalents of the claims.

### BRIEF DESCRIPTION OF THE DRAWINGS

FIGS. 1A and 1B are block diagrams illustrating an exemplary operating environment for transferring digital files in accordance with an implementation of the invention.

FIGS. 2A and 2B are block diagrams illustrating components of systems that may be used to implement the techniques described herein.

FIG. 3 is an example process flow diagram for transferring a digital file in accordance with an implementation of the invention.

### DETAILED DESCRIPTION OF THE INVENTION

The following detailed description is directed to techniques and systems for the transferring of digital files between user input devices and computing devices without requiring an additional peripheral storage device.

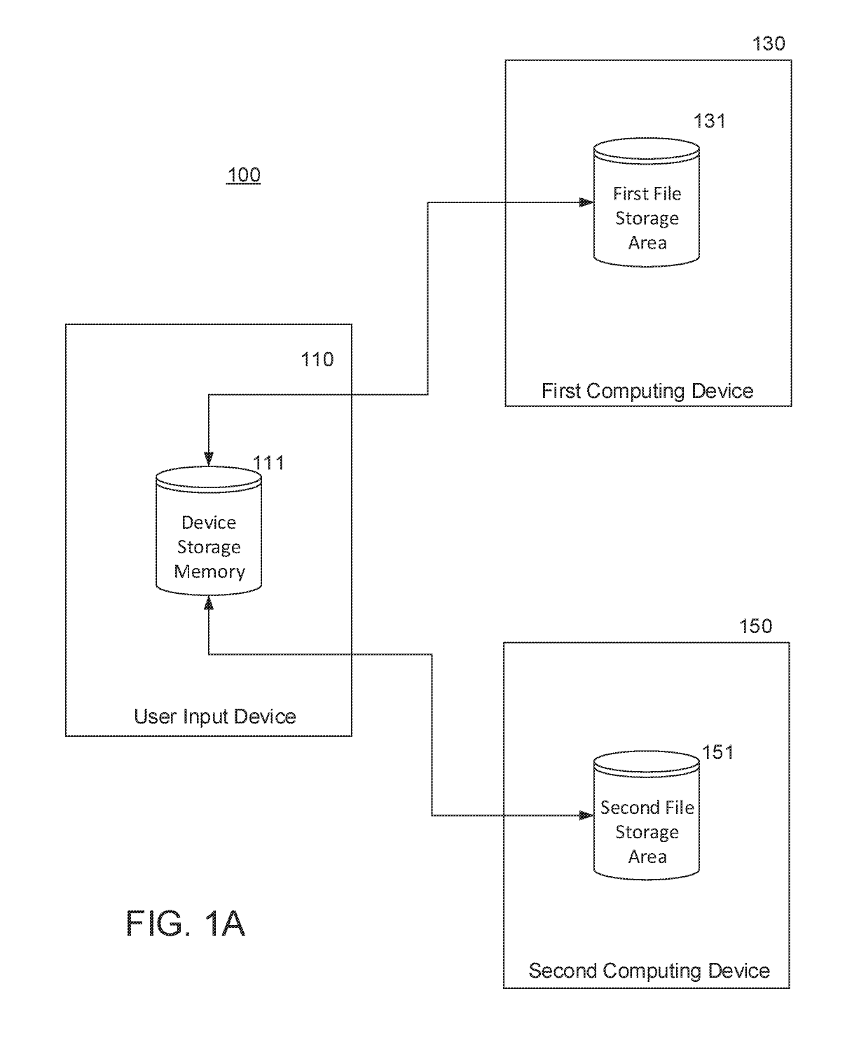

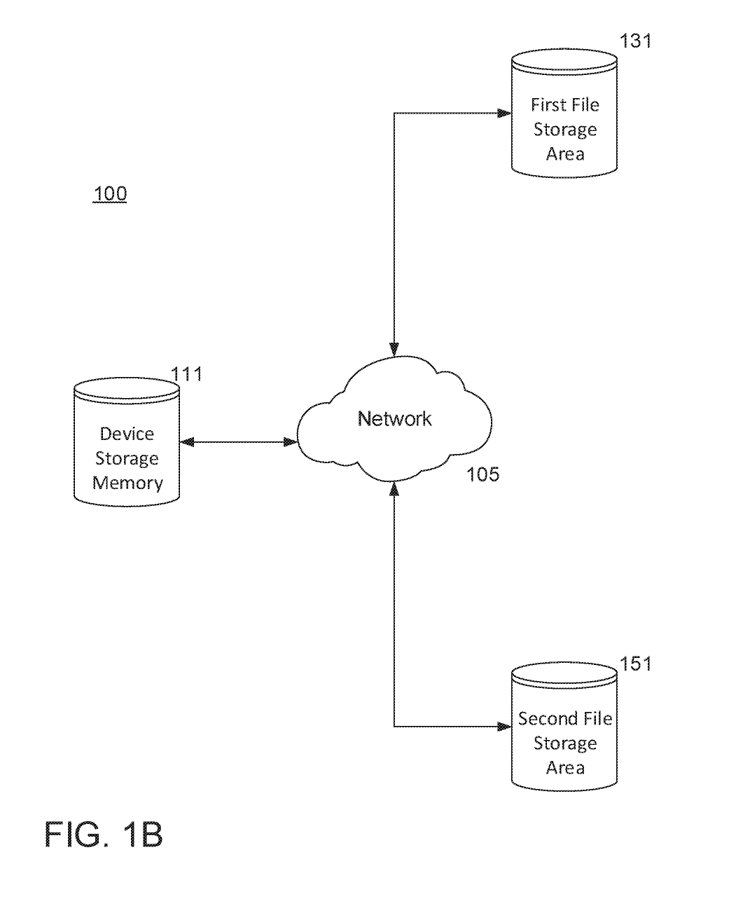

FIG. 1A is a block diagram depicting an operating environment 100 for a digital file transfer system, in accordance with certain exemplary implementations.

Referring to FIG. 1A, the exemplary operating environment 100 includes a first computing device 130, a second computing device 150, and a user input device 110. The user input device 110 may be a keyboard or a pointing device. The pointing device can include a mouse, a trackball, a touchpad, an electronic pen that can be used in conjunction with an electronic tablet, or any other input device, such as a microphone, joystick, game pad, printer, scanner, or the like. These and other user input devices are often connected to computing devices such as the first computing device 130 and the second computing device 150 through a serial port interface, but can be connected by other interfaces, such as a parallel port, game port, a universal serial bus (USB), or the like.

The user input device 110 also includes device storage memory 111 accessible by the first computing device 130 and the second computing device 150. The exemplary device storage memory 111 may comprise any computer readable storage media readable by the first computing device 130 or the second computing device 150 and capable of receiving, transferring, and storing one or more digital files. Throughout the discussion of exemplary implementations, it should be understood that the terms “digital files,” “data,” or “information,” are used interchangeably herein to refer to text, images, audio, video, or any other form of information that can exist in a computer-based environment.

The device storage memory 111 may include volatile and non-volatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium a propagated signal or carrier wave. The device storage memory 111 can be stored on the user input device 110 or can be logically coupled to the user input device 110. For example, the device storage memory 111 can include on-board flash memory and/or one or more removable memory cards or removable flash memory.

The device storage memory 111 may be implemented as a single storage device but may also be implemented across multiple storage devices or sub-systems co-located or distributed relative to each other. The device storage memory 111 may comprise additional elements, such as a controller, capable of communicating with the first computing device 130 or the second computing device 150.

In addition to storage media, in some implementations, the user input device 110 may also include network/communication interfaces that allow for communication with the first computing device 130, second computing device 150, or other computing devices over one or more communication networks (explained in further detail below with respect to FIG. 1B). Network/communications interfaces (not shown) may include communications connections and devices that allow for communication with other computing systems over one or more communication networks (not shown). Examples of connections and devices that together allow for inter-system communication may include network interface cards, near-field communication (NFC) chips, Bluetooth chips, antennas, power amplifiers, radio frequency (RF) circuitry, transceivers, and other communication circuitry. The connections and devices may communicate over communication media (such as metal, glass, air, or any other suitable communication media) to exchange communications with the first computing device 130, second computing device 150, or networks of computing devices.

It should be noted that many elements of the user input device 111 may be included in a system-on-a-chip (SoC) device. These elements may include, but are not limited to, a controller, a network/communications interface, and even elements of the device storage memory 111.

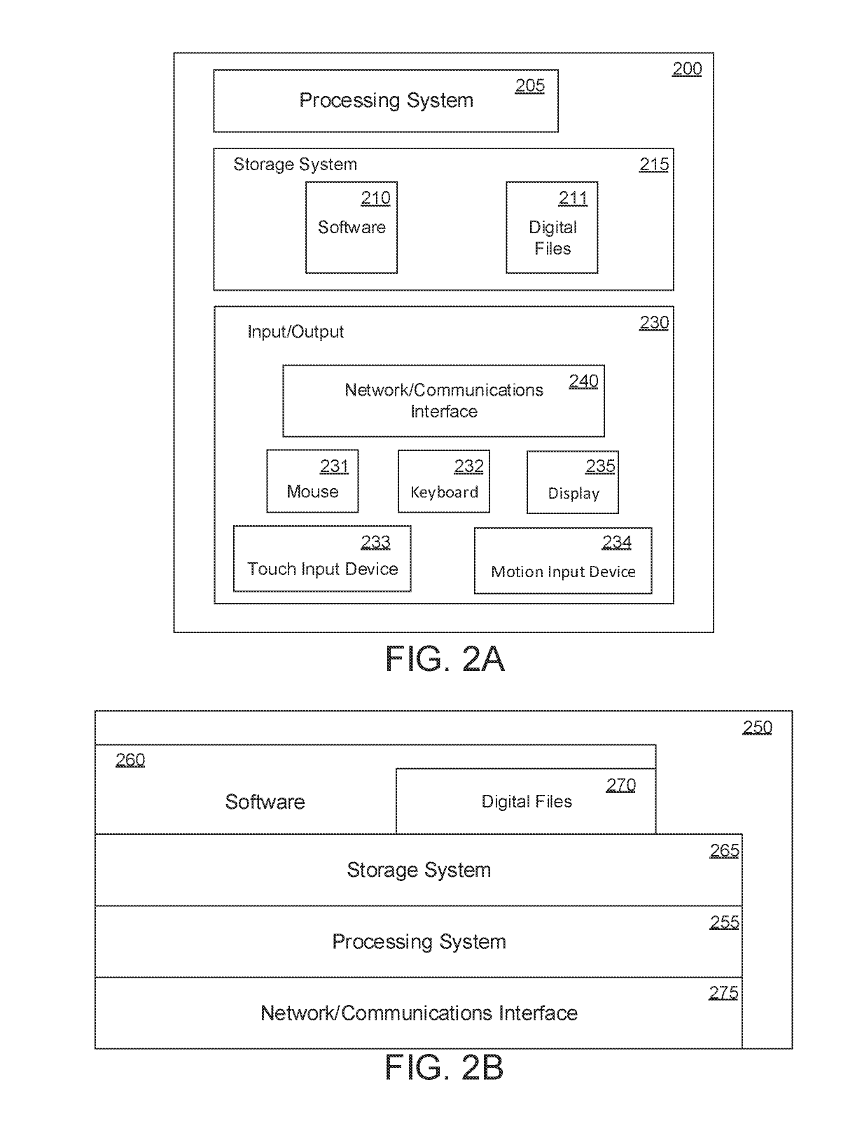

The first computing device 130 and the second computing device 150 include a first file storage area 131 and a second file storage area 151, respectively. However, the first computing device 130 and the second computing device 150 can include one or more additional components such as the components included in exemplary computing device 200 illustrated in FIG. 2A.

Referring to FIG. 2A, system 200 may be implemented within a single computing device (such as the first computing device 130 and the second computing device 150 described herein with respect to FIGS. 1A and 1B) or distributed across multiple computing devices or sub-systems that cooperate in executing program instructions. System 200 may represent a computing device such as, but not limited to, a personal computer, a tablet computer, a reader, a mobile device, a personal digital assistant, a wearable computer, a smartphone, a laptop computer (notebook or netbook), a gaining device or console, a desktop computer, or a smart television. Accordingly, more or fewer elements described with respect to system 200 may be incorporated to implement a particular computing device.

System 200, for example, includes a processing system 205 of one or more processors which processes data according to the instructions of software 210 stored on a storage system 215. Examples of processors of the processing system 205 include general purpose central processing units, application specific processors, and logic devices, as well as any other type of processing device, combinations, or variations thereof.

The software 210 can include an operating system and application programs that facilitate the transfer of one or more digital files 211 between system 200 and user input devices (described above with respect to FIG. 1A). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 2A, can be thought of as additional, nested groupings within the operating system space, each containing an OS, application programs, and APIs.

Storage system 215 (such as the first file storage area 131 or the second file storage area 151 described herein with respect to FIGS. 1A and 1B) may comprise any computer readable storage media readable by the processing system 205 and capable of storing software and one or more digital files 211.

Storage system 215 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium a propagated signal or carrier wave.

In addition to storage media, in some implementations storage system 215 may also include communication media over which software may be communicated internally or externally. Storage system 215 may be implemented as a single storage device but may also be implemented across multiple storage devices or sub-systems co-located or distributed relative to each other. Storage system 220 may comprise additional elements, such as a controller, capable of communicating with processor 205.

Software 210 may be implemented in program instructions and among other functions may, when executed by system 200 in general or processing system 205 in particular, direct system 200 or the one or more processors of processing system 205 to transfer one or more digital files 211 as described herein.

In general, software may, when loaded into processing system 205 and executed, transform computing system 200 overall from a general-purpose computing system into a special-purpose computing system customized to transfer one or more digital files 211 as described herein for each implementation. Indeed, encoding software on storage system 215 may transform the physical structure of storage system 215. The specific transformation of the physical structure may depend on various factors in different implementations of this description. Examples of such factors may include, but are not limited to, the technology used to implement the storage media of storage system 215 and whether the computer-storage media are characterized as primary or secondary storage.

The system 200 can further include input/output (I/O) devices 230. I/O devices can include devices and components that enable communication to and from the system 200. User input and output devices can include input devices such as a mouse 231, track pad (not shown), trackball (not shown) keyboard 232, microphone (not shown), a touch device 233 for receiving a touch gesture from a user, a motion input device 234 for detecting non-touch gestures and other motions by a user, and other types of input devices and their associated processing elements capable of receiving user input. The I/O devices 230 may also include computer readable storage media readable by the system 200 and capable of receiving, transferring, and storing one or more digital files.

The I/O devices 230 may also include output devices such as display screens 235, speakers (not shown), haptic devices for tactile feedback, and other types of output devices. In certain cases, the input and output devices may be combined in a single device, such as a touchscreen display which both depicts images and receives touch gesture input from the user. Visual output may be depicted on the display 235 in myriad ways, presenting graphical user interface elements, text, images, video, notifications, virtual buttons, virtual keyboards, or any other type of information capable of being depicted in visual form. The I/O devices 230 may also include associated software executed by the OS in support of the various user input and output devices. Such software assists the OS in communicating user interface hardware events to application programs using defined mechanisms.

Communications interface 240 may include communications connections and devices that allow for communication with other computing systems over one or more communication networks (not shown). Examples of connections and devices that together allow for inter-system communication may include network interface cards, near-field communication (NFC) chips, Bluetooth chips, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

It should be noted that many elements of system 200 may be included in a system-on-a-chip (SoC) device. These elements may include, but are not limited to, the processing system 205, a communications interface 240, and even elements of the storage system 215.

It should be understood that computing system 200 is generally intended to represent a computing system, such as first computing device 130 or second computing device 150 described herein with respect to FIGS. 1A and 1B, with which software is deployed and executed in order to implement methods for transferring one or more digital files, as described herein. However, computing system 200 may also represent any computing system on which one or more digital files may be stored and from where one or more digital files may be distributed, transported, downloaded, or otherwise provided to yet another computing system for deployment and execution, or yet additional distribution.

FIG. 2B shows a block diagram illustrating components of a system used in some implementations. System 250 may be implemented within a single computing device or distributed across multiple computing devices or sub-systems that cooperate in executing program instructions. The system 250 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 250 can include a processing system 255, which may include one or more processors and/or other circuitry that retrieves and executes software 260 from storage system 265 that facilitates the transfer of one or more digital files 261 between system 250 and user input devices (described above with respect to FIG. 1A). Processing system 255 may be implemented within a single processing device but may also be distributed across multiple processing devices or sub-systems that cooperate in executing program instructions.

Examples of processing system 255 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain implementations, one or more digital signal processors (DSPs) may be included as part of the computer hardware of the system in place of or in addition to a general purpose CPU.

As with storage system 215, storage system 265 may comprise any computer readable storage media readable by processing system 255 and capable of storing software and one or more digital files 261. Storage system 265 may be implemented as a single storage device but may also be implemented across multiple storage devices or sub-systems co-located or distributed relative to each other. Storage system 265 may include additional elements, such as a controller, capable of communicating with processing system 255.

Software 260 may be implemented in program instructions and among other functions may, when executed by system 250 in general or processing system 255 in particular, direct the system 250 or processing system 255 to operate as described herein for transferring one or more digital files 261. Software 260 may provide program instructions for transferring one or more digital files 261. Software 260 may implement on system 250 components, programs, agents, or layers that implement in machine-readable processing instructions the methods described herein as performed by the user input device 110, first computing device 130, and the second computing device 150 (as discussed with respect to FIGS. 1A & 1B).

Software 260 may also include additional processes, programs, or components, such as operating system software or other application software. Software 260 may also include firmware or some other form of machine-readable processing instructions executable by processing system 255.

System 250 may represent any computing system on which one or more digital files 261 may be stored and from where one or more digital files 261 may be distributed, transported, downloaded, or otherwise provided to yet another computing system for deployment and execution, or yet additional distribution.

In implementations where the system 250 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 275 may be included, providing communication connections and devices that allow for communication between system 250 and other computing systems (not shown) over a communication network or collection of networks (not shown) or the air. Examples of connections and devices that together allow for inter-system communication may include network interface cards, near-field communication (NFC) chips, Bluetooth chips, antennas, power amplifiers, radio frequency (RF) circuitry, transceivers, and other communication circuitry.

It should be noted that many elements of system 250 may be included in a system-on-a-chip (SoC) device. These elements may include, but are not limited to, the processing system 255, the communications interface 275, and even elements of the storage system 265 and software 260.

Referring back to FIG. 1A, one or more digital files can be received by the user input device 110 and stored in the device storage memory 111. In one implementation, the user input device may be in communication with the first computing device 130 and/or the second computing device through a wired connection such as a serial port interface, a parallel port, a game port, a universal serial bus (USB), or the like. Once connected, a user of the user input device 110 can interact with a user interface provided by the first computing device 130 or the second computing device 150 to view, add, modify, remove or otherwise access one or more digital files stored on the device storage memory 111 of the user input device 110.

In an alternative implementation, as shown in FIG. 1B, the user of the user input device 110 can interact with a user interface provided by the first computing device 130 or the second computing device 150 to view, add, modify, remove or otherwise access one or more digital files from the device storage memory 111 of the user input device 110 via a distributed network 105. The network 105 includes a wired or wireless telecommunication system or device by which network devices (including devices 110, 130, and 150) can exchange one or more digital files. For example, the network 105 can include, but is not limited to, a cellular network (e.g., wireless phone), a point-to-point dial up connection, a satellite network, the Internet, a local area network (LAN), a wide area network (WAN), a WiFi network, an ad hoc network, a personal area network (e.g., Bluetooth), a near-field communication (NFC) connection, an intranet, an extranet, or any combination thereof.

Additionally, the one or more digital files may be synchronized with a remote storage location, such as a cloud computing environment (not shown). In such an implementation, the user input device can access digital files stored at the remote location using another device, such as a desktop computer connected to the network 105. The remote storage location can update the device storage memory 111 of the user input device 110 in response to any changes made at the remote storage location.

Referring again to FIG. 1A, the one or more digital files stored in the device storage memory 111 of the user input device 110 can be transferred to the first file storage area 131 of the first computing device 130, or the second file storage area 151 of the second computing device 150. Further, the one or more digital files stored on the first file storage area 131 of the first computing device 130, or the second file storage area 151 of the second computing device 150 can be transferred to the device storage memory 111 of the user input device 110. In certain exemplary implementations, each storage system (i.e., the device storage memory 111, the first file storage area 131, and the second file storage area 151) can include a set of computer-readable program instructions that enable the storage systems to interact with one another and facilitate the transfer of one or more digital files. These program instructions can include program instructions for detecting whether the user input device 110 includes one or more digital files and program instructions for detecting the user input device 111 once it is connected to the first computing device 130 or the second computing device 150. Once connected, the user input device 110 can communicate with the first computing device 130 or the second computing device 150. In further exemplary implementations, the computer-readable instructions also include program instructions for downloading or copying digital files from the first file storage area 131 of the first computing device 130, or the second file storage area 151 of the second computing device 150 to the device storage memory of the user input device 110. For example, if the first computing device 130 or the second computing device 150 detects that the user input device 110 does not have one or more selected digital files, the first computing device 130 or the second computing device 150 can prompt the user 101 to download/copy the selected digital files to the device storage memory 111 of the user input device 110. If a user of the user input device 110 elects to download/copy the digital files, the computer-readable program code can download and install the digital files on the device storage memory user input device 110.

In another implementation, the receipt and transfer of one or more digital files may be automatically executed. Upon establishing a connection between the user input device 110 and the first computing device 130 or the second computing device 150, the first computing device 130 or the second computing device 150 can detect whether the user input device 110 has one or more digital files stored on the device storage memory 111. If there are no digital files stored on the device storage memory 111, the first computing device 130 or the second computing device 150 can automatically transfer one or more digital files stored in the first file storage area 131 or the second file storage area 151 to the device storage memory 111. In the alternative, the user input device 110 can detect whether the first computing device 120 or the second computing device 150 has one or more digital files stored on the first file storage area 131 or the second file storage area 151, respectively. If there are no digital files stored on the first file storage area 131 or the second file storage area 151, the user input device 110 can automatically transfer the one or more digital files stored on the device storage memory 111 to the first file storage area 130 or the second file storage area 150.

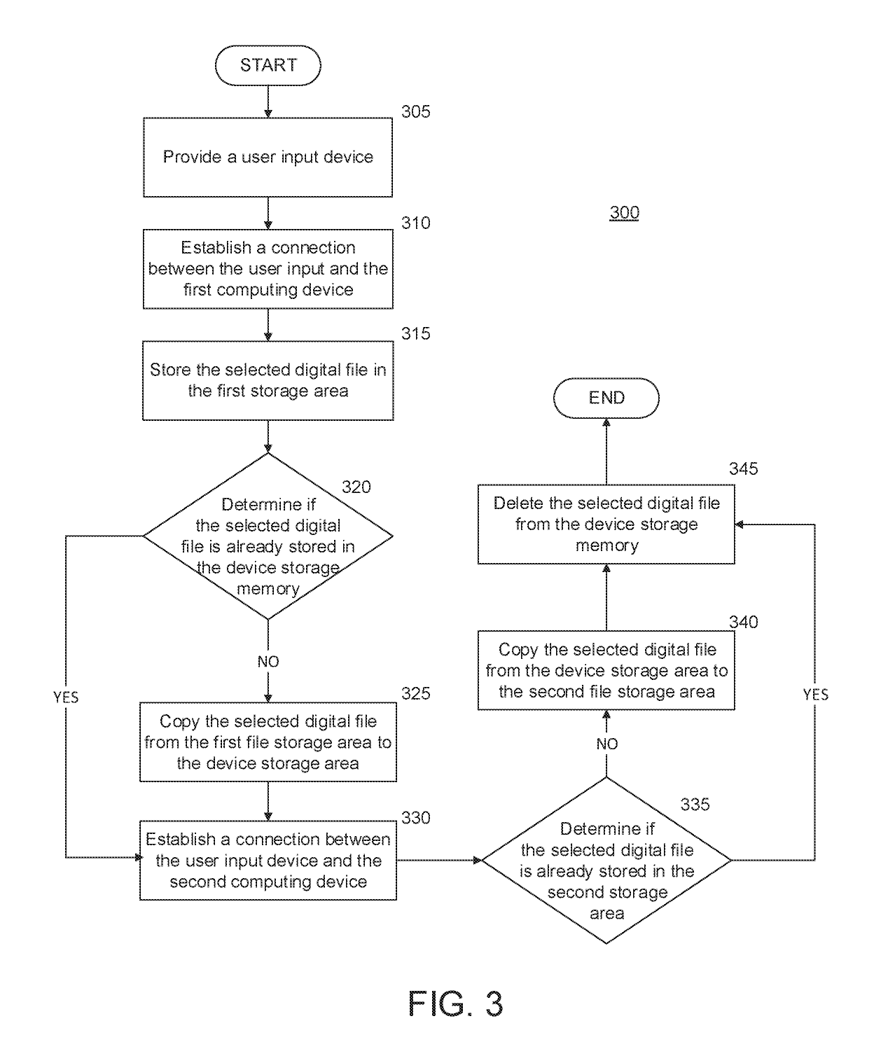

In a further implementation, if the first computing device 130 or the second computing device 150 detects that user input device 110 contains one or more digital files that are also found on the first file storage area 131 or the second file storage area 151, the first computing device 130, the second computing device 150, or the user input device 110 can direct the deletion of the identical digital files from the user input device 110. An exemplary method for completing a digital file transfer using the user input device 110, the first computing device 130, and the second computing device 150 is illustrated in FIG. 3 and discussed below.

FIG. 3 is a flow chart depicting a method 300 for transferring a selected digital file from a first file storage area in a first computing device to a second file storage area in a second computing device, in accordance with certain exemplary implementations. With reference to FIG. 3, in block 305, a user input device comprising a device storage memory is provided. The device storage memory of the user input device is adapted to receive and store digital files from the first computing device and the second computing device. The user input device may also transfer digital files from the device storage memory to the first computing device and the second computing device. In block 310, the user input device and the first computing device establish a connection for communication between the user input device and the first computing device. In one implementation, the first computing device may authenticate the user input device prior to establishing a connection. If the first computing device does not identify the user input device, the first computing device may disconnect the connection between the user input device and the first computing device.

In block 315, after establishing a connection, the selected digital file is stored in the first file storage area. After storing the selected digital file in the first file storage area, the user input device or the first computing device determines whether the selected digital file is already stored on the device storage memory. If the selected digital file is not already stored in the device storage memory, in block 320, the selected digital file is copied from the first file storage area to the device storage memory. If the selected digital file is already stored in the device storage memory, the method proceeds to block 325.

In block 330, the user input device (including the selected digital file stored on the device storage memory) and the second computing device establish a connection for communication between the user input device and the second computing device. In one implementation, the second computing device may authenticate the user input device prior to establishing a connection. If the second computing device does not identify the user input device, the second computing device may disconnect the connection between the user input device and the second computing device.

In block 335, after establishing a connection, the user input device or the second computing device determines whether the selected digital file is already stored in the second file storage area. If the selected digital file is not already stored in the device storage memory, in block 340, the selected digital file is copied from the device storage memory to the second file storage area. If the selected digital file is already stored in the second file storage area, the method proceeds to block 345.

Once it is established that the selected digital file is stored in the second file storage area, in block 345, the selected digital file is deleted from the device storage memory.

In certain embodiments of the present invention, the user may be required to execute an authentication gesture to commence, continue or conclude a file transfer operation. In embodiments where the user input device is a mouse, trackball, joystick or trackpad, for example, the user may be required to “draw” a given figure with input device, or to press one or more buttons, or a combination of buttons, on the mouse in a particular sequence or pattern. In the present context the term “draw” refers to the moving of the mouse, trackball, joystick, or user's finger or a stylus in the case of a trackpad, to trace a shape on a work surface or with an on-screen cursor.

Authentication may also be carried out in certain embodiments by use of biometric devices, such as fingerprint sensors, face detectors, voice recognition sensors, and retinal scanners. These devices may be incorporated into the user input device or may be separate devices connected to the user input device or to the computing environment in which the user input device operates.

Other embodiments of the present invention may include dedicated controls, such as buttons, to initiate, continue, terminate or complete a file transfer operation. Yet additional embodiments may provide sensory feedback, such as a light, or a sound, to indicate that a file transfer operation has commenced or has concluded, or that the user's attention is required to continue with the file transfer operation.

Any reference in this specification to “one implementation,” “an implementation,” an “example implementation,” etc., means that a particular feature, structure, or characteristic described in connection with the implementation is included in at least one implementation of the invention. The appearances of such phrases in various places in the specification are not necessarily referring to the same implementation. In addition, any elements or limitations of any invention or implementation thereof disclosed herein can be combined with any and/or all other elements or limitations (individually or in any combination) or any invention or implementation thereof disclosed herein, and all such combinations are contemplated with the scope of the invention without limitation thereto.

It should be understood that the examples and implementations described herein are for illustrative purposes only and that various modifications or changes in light thereof will be suggested to persons skilled in the art and are to be included within the spirit and purview of this application.

I claim:

1. A digital file transfer system comprising:
a first computing device having a first file storage area;
a second computing device having a second file storage area;
a user input device comprising a device storage memory;
the user input device adapted to:
receive and store in the device storage memory digital files from the first computing device and the second computing device; and
transfer from the device storage memory digital files to the first computing device and the second computing device;
in the first computing device, the second computing device, or the user input device, computer readable storage media having stored therein computer-executable instructions that, when executed by the first computing device, the second computing device, or the user input device, directs:
the copying to the device storage memory of any digital file found in the first file storage area or the second file storage area that is not already stored in the device storage memory;
the copying from the device storage memory to the first storage area or the second file storage area, of any digital file found in the device storage area that is not already stored in the first storage area or the second file storage area; and
the deletion from the device storage memory of any digital file that is already found in the first storage area and the second file storage area.

2. The digital file transfer system of claim 1 wherein said computer readable storage media has stored therein computer-executable instructions that, when executed requires that an authentication gesture be completed on the user input device before the copying or deleting of any of the digital files.

3. The digital file transfer system of claim 2 wherein the user input device is a mouse, trackball, joystick, or touchpad comprising at least one button and the authentication gesture comprises the activation of the least one button in a particular sequence, pattern or combination.

4. The digital file transfer system of claim 2 wherein the user input device is a mouse, trackball, joystick, or touchpad and the authentication gesture comprises the drawing of a particular shape with the user input device.

5. The digital file transfer system of claim 1 wherein the user input device is selected from keyboards, mice, trackballs, joysticks, touchpads and combinations thereof.

6. The digital file transfer system of claim 1 wherein the user input device transfers files to and from the first file storage area or the second file storage area through a wired connection.

7. The digital file transfer system of claim 1 wherein the user input device transfers files to and from the first file storage area or the second file storage area through a wireless connection.

8. The digital file transfer system of claim 4 wherein the wireless connection utilizes a wireless protocol selected from Wi-Fi, Bluetooth, cellular, near field communications, and combinations thereof.

9. A method for transferring a selected digital file from a first file storage area in a first computing device to a second file storage area in a second computing device comprising:
providing a user input device comprising a device storage memory, the user input device adapted to:
receive and store in the device storage memory computer files from the first computing device and the second computing device; and
transfer from the device storage memory digital files to the first computing device and the second computing device;
establishing a connection between the user input device and the first computing device;
storing the selected digital file in the first file storage area determining whether the selected digital file is already stored in the device storage memory, and if the selected digital file is not already stored in the device storage memory, copying the selected digital file from the first file storage area to the device storage memory;
establishing a connection between the user input device and the second computing device;
determining whether the selected digital file is already stored in the second file storage area, and if the selected digital file is not already stored in the second file storage area, copying the selected digital file from the device storage memory to the second file storage area;
erasing the selected file from the device storage memory.

10. The method of claim 9 wherein prior to copying any digital file from, copying any digital file to, or erasing any digital file from, the device storage memory, an authentication gesture must be completed on the user input device.

11. The method of claim 10 wherein the user input device is a mouse, trackball, joystick, or touchpad comprising at least one button and the authentication gesture comprises the activation of the least one button in a particular sequence, pattern or combination.

12. The method of claim 10 wherein the user input device is a mouse, trackball, joystick, or touchpad and the authentication gesture comprises the drawing of a particular shape with the user input device.

13. The method of claim 9 wherein the user input device is selected from keyboards, mice, trackballs, joysticks, touchpads and combinations thereof.

14. The method of claim 9 wherein the user input device copies the selected digital file to and from the first file storage area or the second file storage area through a wired connection.

15. The method of claim 9 wherein the user input device copies the selected digital file to and from the first file storage area or the second file storage area through a wireless connection.

16. The method of claim 9 wherein the wireless connection utilizes a wireless protocol selected from Wi-Fi, Bluetooth, cellular, near field communications, and combinations thereof.
